(19) United States
(12) Patent Application Publication
(10) Pub. No.: US 2009/0024437 A1
(43) Pub. Date: Jan. 22, 2009

(54) Methods, Systems, and Computer-Readable Media for Providing A Ratio of Tasks Per Technician

(76) Inventors: Robert Ingman, Peachtree City, GA (US); Robert Cole, Birmingham, AL (US); Richard Miller, Hoover, AL (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/779,011

(22) Filed: Jul. 17, 2007

(51) Int. Cl. G06Q 10/00

(52) U.S. Cl. 705/9; 718/100

(57) ABSTRACT

Methods, systems, and computer-readable media provide for providing a ratio of tasks per technician. According to embodiments, a method for providing a ratio of tasks per technician is provided. According to the method, a number of tasks associated with a given geography is determined. A number of technicians dispatched to the given geography is determined. The ratio of tasks per technician is determined based on the number of tasks and the number of technicians. The ratio of tasks per technician is displayed.

### CROSS-REFERENCE TO RELATED APPLICATIONS

The present application is related to commonly assigned U.S. patent application Ser. No. ______, filed concurrently herewith, titled “METHODS, SYSTEMS, AND COMPUTER-READABLE MEDIA FOR DETERMINING A PLURALITY OF TURFS FROM WHERE TO REALLOCATE A WORKFORCE TO A GIVEN TURF,” with attorney docket number 070003; commonly assigned U.S. patent application Ser. No. ______, filed concurrently herewith, titled “METHODS, SYSTEMS, AND COMPUTER-READABLE MEDIA FOR GENERATING A REPORT INDICATING JOB AVAILABILITY,” with attorney docket number 070004; commonly assigned U.S. patent application Ser. No. ______, filed concurrently herewith, titled “METHODS, SYSTEMS, AND COMPUTER-READABLE MEDIA FOR PROVIDING AN INDICATION OF A SCHEDULE CONFLICT,” with attorney docket number 070005; commonly assigned U.S. patent application Ser. No. ______, filed concurrently herewith, titled “METHODS, SYSTEMS, AND COMPUTER-READABLE MEDIA FOR PROVIDING AN INDICATION OF HIGHTIME,” with attorney docket number 070006; commonly assigned U.S. patent application Ser. No. ______, filed concurrently herewith, titled “METHODS, SYSTEMS, AND COMPUTER-READABLE MEDIA FOR PROVIDING FUTURE JOB INFORMATION,” with attorney docket number 070007; commonly assigned U.S. patent application Ser. No. ______, filed concurrently herewith, titled “METHODS, SYSTEMS, AND COMPUTER-READABLE MEDIA FOR PROVIDING NOTIFICATION OF A LAST JOB DISPATCH,” with attorney docket number 070008; commonly assigned U.S. patent application Ser. No. ______, filed concurrently herewith, titled “METHODS, SYSTEMS, AND COMPUTER-READABLE MEDIA FOR PROVIDING COMMITMENTS INFORMATION RELATIVE TO A TURF,” with attorney docket number 070009; commonly assigned U.S. patent application Ser. No. ______, filed concurrently herewith, titled “METHODS, SYSTEMS, AND COMPUTER-READABLE MEDIA FOR PROVIDING CONTACT INFORMATION AT TURF LEVEL,” with attorney docket number 070010; and commonly assigned U.S. patent application Ser. No. ______, filed concurrently herewith, titled “METHODS, SYSTEMS, AND COMPUTER-READABLE MEDIA FOR PROVIDING WORKFORCE TO LOAD INFORMATION,” with attorney docket number 060482; each of which is hereby incorporated herein by reference.

### TECHNICAL FIELD

This application relates generally to the field of load balancing. More specifically, the disclosure provided herein relates to the field of dynamic workforce reallocation.

### BACKGROUND

Telecommunications networks may provide a number of services, such as plain old telephone service (“POTS”), digital subscriber line (“DSL”), and cable. A telecommunications network may be divided into a plurality of geographic areas known as turfs. Maintenance of the telecommunications network generally involves a proper reallocation of technicians across the turfs such that work orders can be timely filled. For example, when one turf experiences a high volume of work orders, it may be desirable to reallocate available technicians from another, preferably nearby, turf with a low volume of work orders to help with the high volume. The reallocation of technicians may be based on a number of factors, such as the location, skills, schedule, and availability of the technicians, as well as the priority of the work orders and the amount of time to complete the work orders.

A load balance supervisor (“LBS”) may be assigned to coordinate the reallocation of technicians within a plurality of turfs. The LBS may utilize any suitable information to coordinate the reallocation of technicians. The LBS conventionally relies on turf maps and raw data on technicians and work orders to manually generate useful data. The process of manually generating such useful data may be time-consuming and labor intensive. Further, if the LBS is unfamiliar with the turfs (e.g., the LBS is assigned to a recent disaster area), the LBS may be unable to generate the useful data.

### SUMMARY

Embodiments of the disclosure presented herein include methods, systems, and computer-readable media for providing a ratio of tasks per technician. According to one aspect, a method for providing a ratio of tasks per technician is provided. According to the method, a number of tasks associated with a given geography is determined. A number of technicians dispatched to the given geography is determined. The ratio of tasks per technician is determined based on the number of tasks and the number of technicians. The ratio of tasks per technician is displayed.

According to another aspect, a system for providing a ratio of tasks per technician is provided. The system includes a memory and a processor functionally coupled to the memory. The memory stores a program containing code for providing a ratio of tasks per technician. The processor is responsive to computer-executable instructions contained in the program and operative to determine a number of tasks associated with a given geography, determine a number of technicians dispatched to the given geography, determine the ratio of tasks per technician based on the number of tasks and the number of technicians, and determine the ratio of tasks per technician.

According to yet another aspect, a computer-readable medium having instructions stored thereon for execution by a processor to perform a method for providing a ratio of tasks per technician is provided. According to the method, a number of tasks associated with a given geography is determined. A number of technicians dispatched to the given geography is determined. The ratio of tasks per technician is determined based on the number of tasks and the number of technicians. The ratio of tasks per technician is displayed.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a diagram of an exemplary embodiment of a graphical user interface (“GUI”) in a previous version.

FIG. 2 is a high-level diagram illustrating an allocation of technicians for maintaining and repairing a telecommunications network, in accordance with exemplary embodiments.

FIG. 3 is a block diagram illustrating a computer configured to provide a GUI that aids in the reallocation of the technicians across a plurality of turfs, in accordance with exemplary embodiments.

FIG. 4 is a block diagram of a workforce reallocation system, in accordance with exemplary embodiments.

FIG. 5 is a diagram of a GUI, in accordance with exemplary embodiments

FIG. 6 is a diagram of a drop-down window in the GUI of FIG. 5, in accordance with exemplary embodiments.

FIG. 7 is a flow diagram illustrating a method for providing a ratio of tasks per technician, in accordance with exemplary embodiments.

### DETAILED DESCRIPTION

The following detailed description is directed to methods, systems, and computer-readable media for determining a plurality of turfs from where to reallocate a workforce to a given turf. In the following detailed description, references are made to the accompanying drawings that form a part hereof, and which are shown by way of illustration specific embodiments or examples.

As used herein, the terms “work order,” “job,” and “task” are used interchangeably. Although not so limited, embodiments described herein primarily refer to a “work order” as the maintenance and repair of a telecommunications network by a technician. However, it will be apparent to one of ordinary skill in the art that, in further embodiments, a “work order” may include any suitable service that involves the allocation and reallocation of personnel to perform the service.

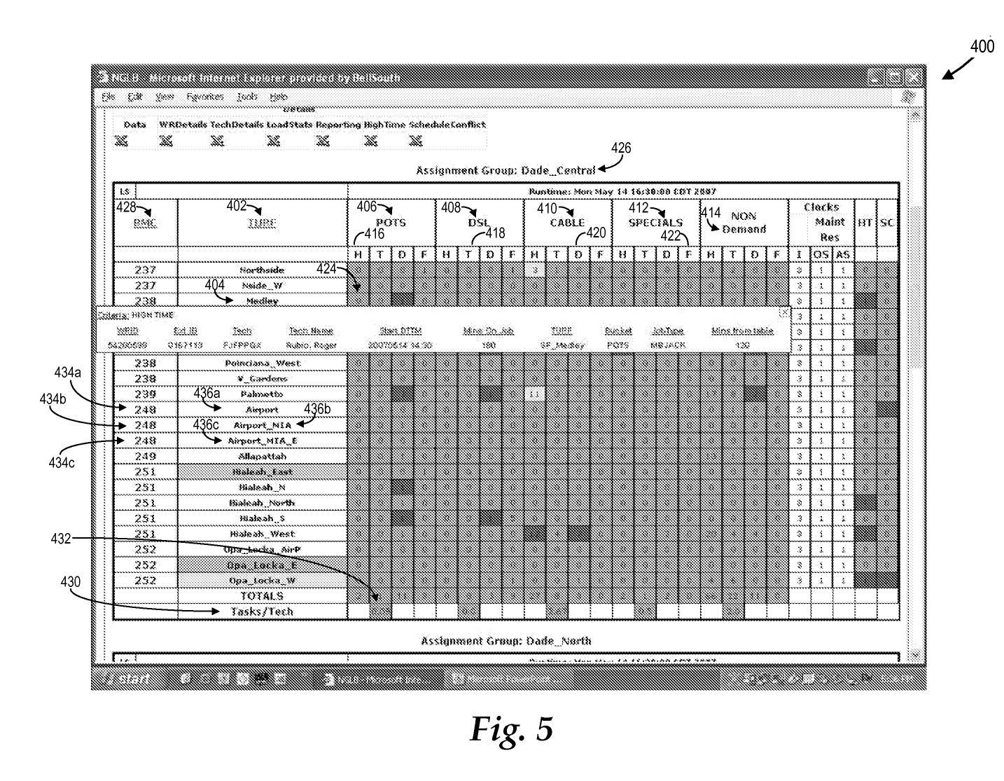

Embodiments described herein provide a Next Generation Load Balance (“NGLB”) tool for work force reallocation. According to exemplary embodiments, the NGLB tool has a graphical user interface (“GUI”), such as a GUI 400 of FIG. 5, containing an organized overview of work order and technician statuses within a plurality of turfs. The NGLB tool may be utilized by a load balance supervisor (“LBS”) or other load balancing personnel to aid in the coordination of work force reallocation within the plurality of turfs. In one embodiment, the NGLB tool is provided to the LBS as a web-based application that can be accessed remotely via, for example, a web browser. In addition, the NGLB tool may be stored on a computing device used by the LBS to balance personnel.

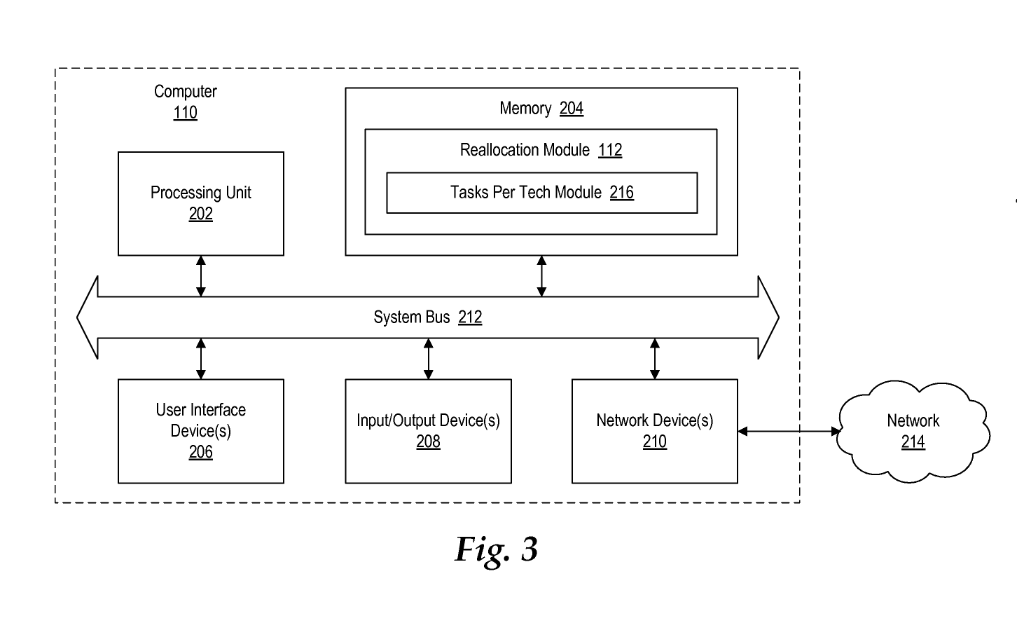

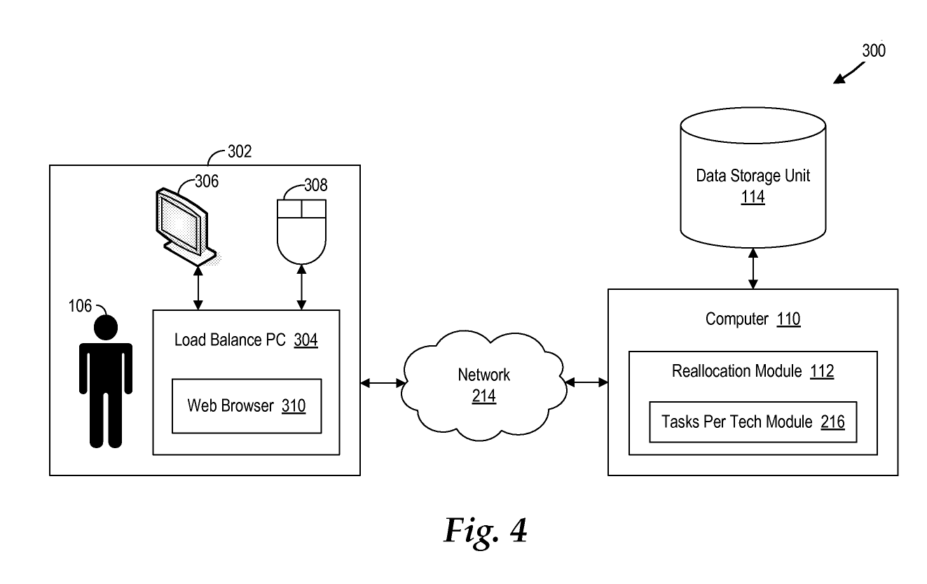

According to further embodiments, the NGLB tool includes a tasks per tech module, such as a tasks per tech module 216 of FIGS. 3 and 4. The tasks per tech module 216 may provide a visual presentation of a ratio of tasks per technician, such as the technicians 102, across a given number of turfs, such as a Medley turf 404, in accordance with exemplary embodiments. The ratio of tasks per technician may provide an indication of workforce load associated with the given number of turfs. The tasks per tech module 216 may provide the ratio of tasks per technician via a GUI, such as the GUI 400 of FIG. 5, as described in greater detail below. In one example, the LBS may utilize the ratio of tasks per technicians to reallocate technicians, such as the technicians 102, between turfs, such as the Medley turf 404.

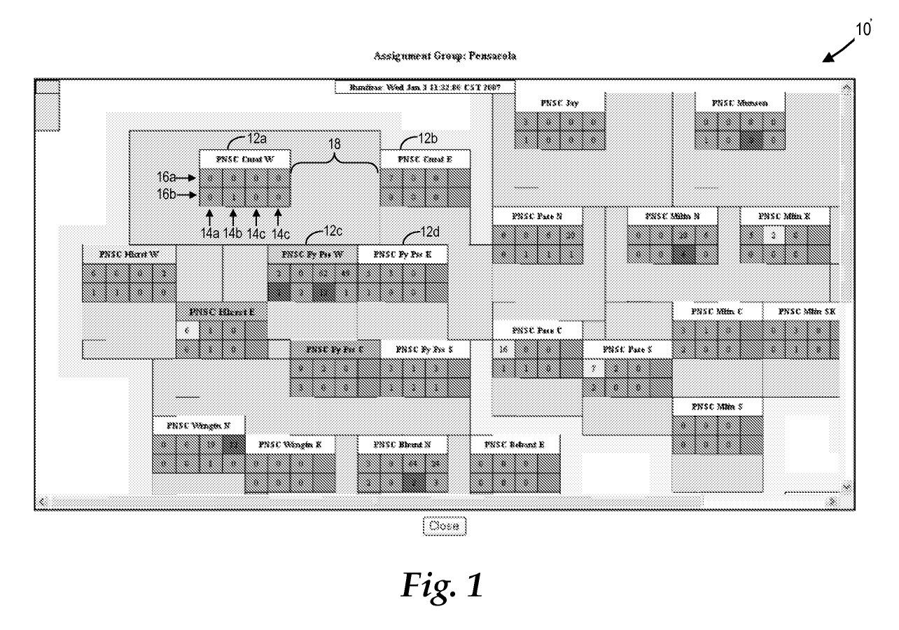

Referring now to the drawings, it is to be understood that like numerals represent like elements through the several figures, and that not all components and/or steps described and illustrated with reference to the figures are required for all embodiments. FIG. 1 is an exemplary embodiment of the GUI 10 utilized in a previous version of the NGLB tool implemented by assignee of this application on or about April 2005. As illustrated in FIG. 1, the GUI 10 includes a plurality of turfs, such as turfs 12a, 12b, 12c, 12d. Each of the turfs, such as the turf 12a, includes four columns 14a, 14b, 14c, 14d. Each of the four columns 14a, 14b, 14c, 14d includes a first cell 16a and a second cell 16b. The first cell 16a includes job information and the second cell 16b includes technician information, according to one embodiment. The GUI 10 provides map presentation of the turfs 12a, 12b, 12c, 12d. The map presentation provides a visual mapping of physical distances between each of the plurality of the turfs 12a, 12b, 12c, 12d. In one example, the physical distance between the turf 12a and the turf 12b is a distance 18. In another example, the turf 12c and turf 12d are contiguous as indicated by the turf 12c being in contact with the turf 12d in the GUI 10.

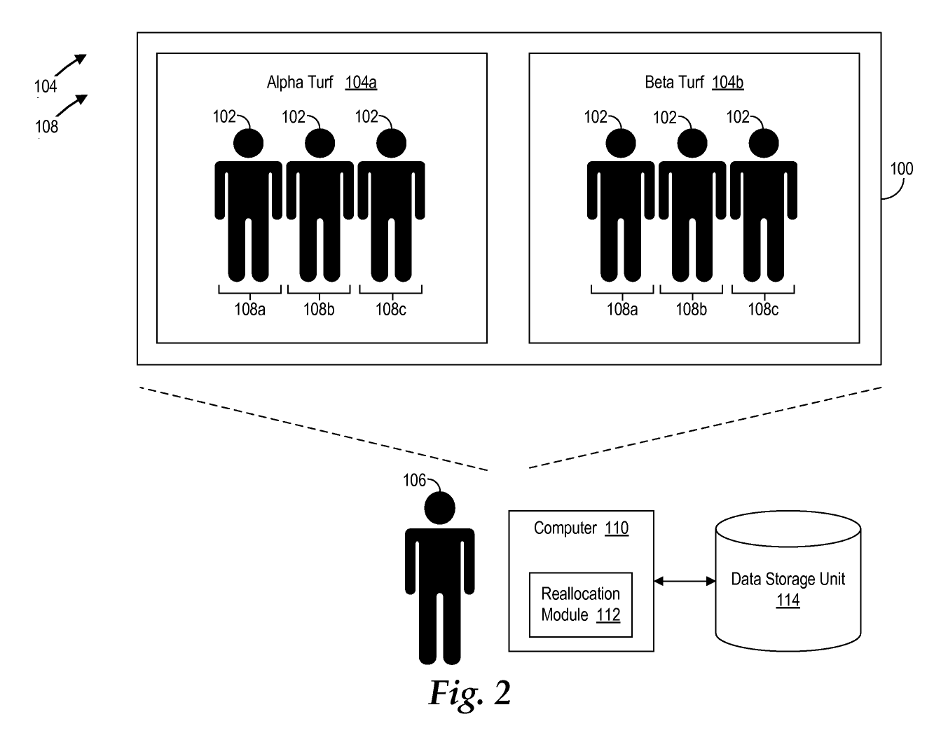

FIGS. 2-7 as described below illustrate a current version of the NGLB tool. FIG. 2 is a high-level diagram illustrating an allocation of the technicians 102 for maintaining and repairing a telecommunications network 100, in accordance with exemplary embodiments. The telecommunications network 100 is maintained and repaired by a plurality of the technicians 102. As illustrated in FIG. 2, each of the technicians 102 is assigned to an Alpha turf 104a or a Beta turf 104b (collectively turfs 104) by a LBS 106 or other load balancing personnel, according to exemplary embodiments. Each turf 104 includes a plain old telephone service (“POTS”) bucket 108a, a digital subscriber line (“DSL”) bucket 108b, and a cable bucket 108c (collectively buckets 108), according to one embodiment. Each of the buckets 108 represents a discipline in which one or more of the technicians 102 may be assigned based on the skill set of the technician 102. In particular, the technician 102 in the POTS bucket 108a should have a skill set for completing POTS related work orders. The technician 102 in the DSL bucket 108b should have a skill set for completing DSL related work orders, and the technician 102 in the cable bucket 108c should have a skill set for completing cable related work orders. In one embodiment, one or more of the technicians 102 may include multiple skill sets for completing work orders under multiple buckets 108. The technicians 102 may be managed by one or more field supervisors (not shown). For example, the technicians 102 in each bucket 108 may be managed by a separate field supervisor.

For the sake of simplicity and without limitation, only two turfs 104a and 104b and three buckets 108a, 108b, and 108c are illustrated in FIG. 2. However, it will be apparent to those of ordinary skill in the art that the telecommunications network 100 may include any suitable number of turfs 104 and any suitable number and types of buckets 108, according to further embodiments.

The LBS 106 utilizes a computer 110 to aid in reallocating the plurality of technicians 102 across the turfs 104. The computer 110 includes a reallocation module 112, which enables the computer 110 to display a graphical user interface (“GUI”), such as the GUI 400 of FIG. 5, that provides the LBS 106 with an organized, visual presentation of the technicians 102, the turfs 104, and the buckets 108, according to one embodiment. In one example, if work orders in the Alpha turf 104a cannot be timely filled without additional technicians 102, the LBS 106 may view the GUI 400 to determine if the technicians 102 in the Beta turf 104b can be utilized. In a further example, if service orders in the POTS bucket 108a cannot be timely filled without additional technicians 102, the LBS 106 may view the GUI 400 to determine if the technicians 102 in the DSL bucket 108b or the cable bucket 108c are qualified to fill POTS work orders. In one embodiment, the computer 110 functions as a web server located remotely from the LBS 106 by executing a web server application, such as BEA WEBLOGIC SERVER from BEA SYSTEMS. In this embodiment, the LBS 106 may access the GUI 400 over a network, such as a network 214 of FIGS. 3 and 4, using, for example, a local web browser interface on a personal computer (“PC”) or other computing device.

In one embodiment, the reallocation module 112 generates at least a portion of the GUI 400 based on data stored in a data storage unit 114. The data storage unit 114 may store any suitable data related to the technicians 102, such as the location, skills, schedule, and availability of the technicians 102. The data storage unit 114 may be a database. In one embodiment, the data storage unit 114 is an Integrated Dispatch System (“IDS”). The IDS is described in greater detail in U.S. Patent Application Publication No. 2004/0111311, entitled “Turfs and Skills for Multiple Technicians,” to Ingman et al.; U.S. Patent Application Publication No. 2004/0111312, entitled “Validating Turfs for Work Orders,” to Ingman et al.; U.S. Patent Application Publication No. 2004/0111313, entitled “Methods and Systems for Assigning Multiple Tasks,” to Ingman et al.; and U.S. Patent Application Publication No. 2004/0111634, entitled “Security Permissions for an Integrated Dispatch System,” to Ingman et al.

FIG. 3 and the following discussion are intended to provide a brief, general description of the computer 110 in which embodiments may be implemented. While embodiments will be described in the general context of program modules that execute in conjunction with an application program that runs on an operating system on a computer system, those skilled in the art will recognize that the embodiments may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

FIG. 3 is a block diagram illustrating the computer 110 configured to provide a GUI, such as the GUI 400 of FIG. 5, that aids in the reallocation of the technicians 102 across the turfs 104, in accordance with exemplary embodiments. The computer 110 includes a processing unit 202, a memory 204, one or more user interface devices 206, one or more input/output (“I/O”) devices 208, and one or more network devices 210, each of which is operatively connected to a system bus 212. The bus 212 enables bi-directional communication between the processing unit 202, the memory 204, the user interface devices 206, the I/O devices 208, and the network devices 210.

The processing unit 202 may be a standard central processor that performs arithmetic and logical operations, a more specific purpose programmable logic controller (“PLC”), a programmable gate array, or other type of processor known to those skilled in the art and suitable for controlling the operation of the server computer. Processing units are well-known in the art, and therefore not described in further detail herein.

The memory 204 communicates with the processing unit 202 via the system bus 212. In one embodiment, the memory 204 is operatively connected to a memory controller (not shown) that enables communication with the processing unit 202 via the system bus 212. According to exemplary embodiments, the memory 204 includes the reallocation module 112. In one embodiment, the reallocation module 112 is embodied in computer-readable media containing instructions that, when executed by the processing unit 202, generates a GUI, such as the GUI 400 of FIG. 5, containing information related to the reallocation of the technicians 102 across a plurality of the turfs 104, as described in greater detail below. Exemplary information related to the reallocation across a plurality of the turfs 104 includes, but is not limited to, the physical proximity between the technicians 102, the availability of the technicians 102, the physical proximity between the turfs 104, the existing load on each of the turfs 104, and the anticipated load on each of the turfs 104. According to further embodiments, the reallocation module 112 may be embodied in hardware, software, firmware, or any combination thereof.

As illustrated in FIG. 3, the reallocation module 112 includes a tasks per tech module 216. In one embodiment, the tasks per tech module 216 is embodied in computer-readable media containing instructions that, when executed by the processing unit 202, provides a ratio of tasks per technician across a given number of turfs, such as the Medley turf 404, as described in greater detail below. According to further embodiments, the tasks per tech module 216 may be embodied in hardware, software, firmware, or any combination thereof.

As described above, the ratio of tasks per technician may provide an indication of workforce load associated with the given number of turfs. For example, a higher ratio of tasks per technician for the Alpha turf 104a may indicate that the Alpha turf 104a has a higher workforce load (e.g., an excess of jobs relative to the number of technicians 102 associated with the Alpha turf 104a), while a lower ratio of tasks per technician for the Beta turf 104b may indicate that the Beta turf 104b has a lower workforce load (e.g., a shortage of jobs relative to the number of technicians 102 associated with the Beta turf 104b). In this case where the Alpha turf 104a has a higher workforce load than the Beta turf 104b, the LBS 106 may decide to reallocate the technicians 102 from the Beta turf 104b to the Alpha turf 104a, thereby reducing or eliminating the difference between the workforce loads associated with the Alpha turf 104a and the Beta turf 104b.

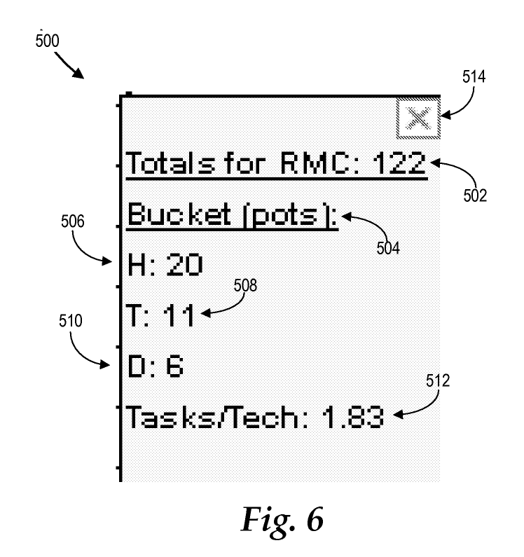

In one embodiment, the tasks per tech module 216 provides the ratio of tasks per technician via a GUI, such as the GUI 400 of FIG. 5. The GUI 400 enables the ratio of tasks per technician to be displayed in an organized, visual presentation relative to a plurality of turfs. As described in greater detail below, the GUI 400 may include a tasks per tech row, such as a tasks per tech row 430. The tasks per tech row 430 may include a plurality of cells, such as a cell 432, each of which indicates a ratio of tasks per technician for a bucket, such as the buckets 406, 408, 410, 412, 414, 416. The GUI 400 may further include a drop-down window, such as a drop-down window 500 of FIG. 6, which provides the ratio of tasks per technician for a selected turf, such as the turfs 402.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 110.

The user interface devices 206 may include one or more devices with which a user accesses the computer 110. The user interface devices 206 may include, but are not limited to, computers, servers, personal digital assistants, cellular phones, or any suitable computing devices. In one embodiment, the computer 110 functions as a web server located remotely from the LBS 106 by executing a web server application, such as BEA WEBLOGIC SERVER from BEA SYSTEMS. By enabling the computer 110 to function as a web server, the LBS 106 may access the GUI 400 generated by the computer 110 over a network, such as the network 214, using, for example, a local web browser interface on a PC or other computing device.

According to exemplary embodiments, the I/O devices 208 enable a user to interface with the reallocation module 112. In one embodiment, the I/O devices 208 are operatively connected to an I/O controller (not shown) that enables communication with the processing unit 202 via the system bus 212. The I/O devices 208 may include one or more input devices, such as, but not limited to, a keyboard, a mouse, and an electronic stylus. Further, the I/O devices 208 may include one or more output devices, such as, but not limited to, a display screen and a printer.

The network devices 210 enable the computer 110 to communicate with other networks or remote systems via the network 214. Examples of the network devices 210 may include, but are not limited to, a modem, a radio frequency (“RF”) or infrared (“IR”) transceiver, a telephonic interface, a bridge, a router, or a network card. The network 214 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 214 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

FIG. 4 is a block diagram of a workforce reallocation system 300, in accordance with exemplary embodiments. The workforce reallocation system 300 includes the computer 110, a network dispatch center (“NDC”) 302, and the data storage unit 114, each of which is operatively connected to the network 214. The NDC 302 includes a load balance PC 304, which is utilized by the LBS 106, according to one embodiment. In further embodiments, the NDC 302 may include any suitable number of load balance PCs 304 to be utilized by any suitable number of LBSs 106. The data storage unit 114 may store any suitable data regarding the technicians 102, such as their location, skills, schedule, and availability. In one embodiment, the reallocation module 112 retrieves data from the data storage unit 114 to generate a GUI, such as the GUI 400 of FIG. 5. The data storage unit 114 may be a database. In one embodiment, the data storage unit 114 is an IDS.

The load balance PC 304 includes a display 306 and a mouse 308, according to one embodiment. In further embodiments, the load balance PC 304 may include any suitable input/output devices 208. It will be apparent to one having ordinary skill in the art that the load balance PC 304 may be substituted with any suitable computing device, such as a personal digital assistant or a cellular phone. The display 306 may be configured to display the GUI 400 and the ratio of tasks per tech provided by the tasks per tech module 216.

In exemplary embodiments, the load balance PC 304 includes a web browser 310, such as INTERNET EXPLORER from MICROSOFT CORPORATION, for accessing the GUI 400 and for facilitating communications between the LBS 106 and the computer 110. Using the web browser 310, the LBS 106 may access the GUI 400 by inputting a Uniform Resource Locator (“URL”) into the web browser 310. The load balance PC 304 may communicate with the computer 110 via Hypertext Transfer Protocol (“HTTP”). As previously described, the computer 110 may function as a web server. In one embodiment, access to the GUI 400 by the load balance PC 304 may be restricted by a login screen requiring, for example, a login identification and a password. In further embodiments, communications between the load balance PC 304 and the computer 110 may be encrypted by any suitable encryption mechanism.

In exemplary embodiments, the computer 110 may communicate with the data storage unit 114 via a Java Database Connectivity (“JDBC”) application program interface (“API”). In one embodiment, the computer 110 retrieves data from the data storage unit 114 at regular intervals, such as every two to five minutes. In further embodiments, the computer 110 retrieves data from the data storage unit 114 when requested by the LBS 106. In other embodiments, the reallocation module 112 may be stored on the load balance PC 304 such that the GUI 400 is accessed from the load balance PC 304 and such that the load balance PC communicates with and retrieves data from the data storage unit 114.

FIG. 5 is an exemplary embodiment of the GUI 400. In one embodiment, the GUI 400 is generated by the reallocation module 112 of the computer 110. The LBS 106 may view the GUI 400 on the display 306 via the web browser 310 associated with the load balance PC 304. In one embodiment, various portions of the GUI 400 are accessible by an input device, such as the mouse 308. It should be appreciated that the GUI 400 illustrated in FIG. 5 is only an exemplary embodiment. It will be apparent to one having ordinary skill in the art that in other embodiments, the GUI 400 may be displayed differently (e.g., as a map presentation), may omit certain fields, or may include other fields.

According to exemplary embodiments, the GUI 400 includes a plurality of turfs 402, such as the Medley turf 404. The GUI 400 may further include a plurality of buckets: the POTS bucket 406, the DSL bucket 408, the Cable bucket 410, the Specials bucket 412, and the Non-Demand (“ND”) bucket 414. According to exemplary embodiments, each of the buckets 406, 408, 410, 412, 414 includes four columns: an Hours column 416, a Tickets column 418, a Dispatched Technicians (hereinafter referred to as Dispatches) column 420, and a Future Tickets (hereinafter referred to as Futures) column 422. Each of a plurality of cells 424 and 432 may be associated with a column, a bucket, and a turf. For example, the cell 424 is associated with the Hours column 416, the POTS bucket 406, and the Medley turf 404.

Each of the plurality of turfs 402, such as the Medley turf 404, may refer to any suitable geographic area. For example, the Medley turf 404 refers to the city of Medley, Fla. As illustrated in FIG. 5, the GUI 400 displays the turfs 402, including the Medley turf 404, contained in a central Dade assignment group (“AG”) 426. In one embodiment, the NDC 302 includes a plurality load balance PCs, such as the PC 304, where each load balance PC corresponds to a different AG, such as the AG 426.

According to exemplary embodiments, the POTS bucket 406 contains information related to POTS related work orders. The DSL bucket 408 contains information related to DSL related work orders. The Cable bucket 410 contains information related cable related work orders. The Specials bucket 412 contains information related to special circuit related work orders, such as Digital Signal 1 (“DS1”) and Digital Signal 3 (“DS3”). The ND bucket 414 is a catch-all bucket containing information related to work orders not categorized in the POTS bucket 406, the DSL bucket 408, the Cable bucket 410, or the Specials bucket 412.

The Hours column 416 indicates the number of hours of pending and assigned work orders in each of the plurality of turfs 402. As used herein, an assigned work order is defined as a work order that is assigned to a technician, such as the technician 102, and a pending work order is defined as a work order that is not assigned to a technician 102 and is to be completed within the current business day. The Tickets column 418 indicates the number of tickets (i.e., work orders) corresponding to the number of hours shown in the Hours column 416 of one of the buckets 406, 408, 410, 412, 414. The Dispatches column 420 indicates the number of technicians 102 dispatched. The Futures column 422 indicates the number of future jobs to be completed by the technicians 102.

According to exemplary embodiments, the GUI 400 includes the tasks per tech row 430. The tasks per tech row 430 may include a plurality of cells, such as the cell 432, each of which indicates an aggregate ratio of tasks per tech associated with a given bucket, such as, the buckets 406, 408, 410, 412, 414, and the turfs 402 in the AG, such as the central Dade AG 426. For example, the cell 432 indicates that the aggregate ratio of tasks per technician associated with the plurality of turfs 402 in the POTS bucket 406 in the central Dade AG 426 is 0.09. In one embodiment, the aggregate ratio displayed in the cell 432 is determined by adding a number of tickets of each turf 402 under the Tickets column 418 to generate a total number of tickets for the POTS bucket 406. The total number of tickets may be divided by a total number of technicians 102 under each turf, such as the turfs 402, in the POTS bucket 406 to generate the aggregate ratio of tasks per technician. As noted above, the dispatches column 420 associated with each of the buckets 406, 408, 410, 412, 414 indicates the number of the technicians 102 under each of the turfs 402.

The GUI 400 may further include a Regional Maintenance Center (“RMC”) column 428, which indicates the RMC number designated to a particular turf. Each RMC number may be associated with one or more turfs 402. For example, RMC number “248” at 434a, 434b, 434c are associated with an airport turf 436a, a Miami airport turf 436b, and an east Miami airport turf 436c, respectively. In one embodiment, each RMC number listed under the RMC column 428 may be accessible by an input device, such as the mouse 308. For example, a RMC number may be accessed by hovering a mouse cursor over the RMC number or by clicking the RMC number using the mouse 308. In response to accessing the RMC number, GUI 400 may display a window, such as the drop-down window 500, according to one embodiment. The drop-down window 500 may include information related to each of the buckets 406, 408, 410, 412, 414, such as hours, tickets, and dispatches. In one embodiment, the drop-down window 500 further includes a ratio of tasks per technician associated a selected RMC number and one or more buckets, such as the buckets 406, 408, 410, 412, 414.

FIG. 6 is an exemplary of the drop-down window 500. As illustrated in FIG. 6, the drop-down window 500 includes information related to RMC “122” and the POTS bucket 406 as shown at 502 and 504, respectively. Although only the POTS bucket 406 is shown in FIG. 6, it will be apparent to one having ordinary skill in the art that the drop-down window 500 may include other buckets or additional buckets, such as the DSL bucket 408, the Cable bucket 410, the Specials bucket 412, and the ND bucket 414. According to exemplary embodiments, the drop-down window 500 includes an Hours portion 506, a Tickets portion 508, a Dispatches portion 510, and a Tasks Per Tech portion 512. The drop-down window 500 may further include a terminate button 514 with which to close the drop-down window 500.

As used herein, the Hours portion 506 indicates the number of hours of pending and assigned work orders associated with each of the turfs 402 in the POTS bucket 406 at 504 of the RMC “122” at 502. The Tickets portion 508 indicates the number of tickets corresponding to the number of hours shown in the Hours portion 506. The Dispatches portion 510 indicates the number of technicians 102 dispatched in the POTS bucket 406 at 504 of the RMC “122” at 502. The Tasks Per Tech portion 512 indicates a ratio of tasks per technician associated with the POTS bucket 406 at 504 of the RMC “122” at 502. As illustrated in FIG. 6, the Tasks Per Tech portion 512 indicates a ratio of 1.83 tasks per technician associated with the POTS bucket 406 of the RMC “122”. In one embodiment, the ratio of 1.83 tasks per technician is determined by dividing the number of tickets (i.e., eleven) shown at the Tickets portion 508 by a number of technicians 102 (i.e., six) shown in the Dispatches portion 510 associated with the POTS bucket 406 of the RMC “122”. As described above, the information for determining the ratio of tasks per technician may be retrieved from the data storage unit 114, such as an IDS.

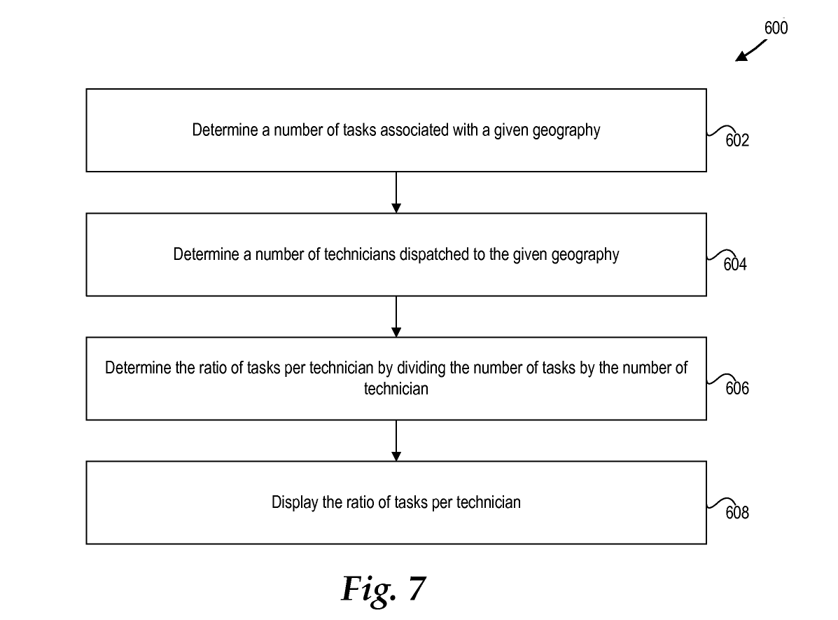

FIG. 7 is a flow diagram illustrating a method 600 for providing a ratio of tasks per technician, in accordance with exemplary embodiments. According to the method 600, the tasks per tech module 216 determines (at 602) a number of tasks associated with a given geography. In one embodiment, the given geography includes one or more turfs, such as the turfs 402. Separate numbers of tasks may be determined for each bucket, such as the buckets 406, 408, 410, 412, 414, in the given geography. For example, a first number of tasks may correspond to those tasks associated a first bucket of the given geography, and a second number of tasks may correspond to those tasks associated with a second bucket of the given geography.

The tasks per tech module 216 determines (at 604) a number of technicians, such as the technicians 102, currently dispatched to the given geography. Separate numbers of technicians 102 may be determined for each bucket, such as the buckets 406, 408, 410, 412, 414, in the given geography. For example, a first number of technicians 102 may correspond to those technicians 102 dispatched to the first bucket of the given geography, and a second number of technicians 102 may correspond to those technicians 102 dispatched to the second bucket of the given geography.

The tasks per tech module 216 determines (at 606) the ratio of tasks per technician by dividing the number of tasks by the number of technicians 102. Separate ratios of tasks per technician may be determined for each bucket, such as the buckets 406, 408, 410, 412, 414, of the given geography. For example, a first ratio of tasks per technician may be determined by dividing the first number of tasks by the first number of technicians 102, and a second ratio of tasks per technician may be determined by dividing the second number of tasks by the second number of technicians 102.

The tasks per tech module 216 displays (at 608) the ratio of tasks per technician. In one embodiment, the ratio of tasks per technician is displayed in a cell, such as the cell 432, of a GUI, such as the GUI 400. In one embodiment, separate ratios of tasks per technician associated with separate buckets, such as the buckets 406, 408, 410, 412, 414, of the given geography may be displayed in separate cells of the GUI 400. For example, a first cell may display the first ratio of tasks per technician, and a second cell may display the second ratio of tasks per technician. In one embodiment, each RMC number, such as the RMC number “248” at 434a, 434b, 434c, in the RMC column 428 may be accessed by an input device, such as the mouse 308, to retrieve an aggregate ratio of tasks associated with the selected RMC number. Each RMC number may correspond to one or more turfs 402.

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A method for providing a ratio of tasks per technician, comprising:
determining a number of tasks associated with a given geography;
determining a number of technicians dispatched to the given geography;
determining the ratio of tasks per technician based on the number of tasks and the number of technicians; and
displaying the ratio of tasks per technician.

2. The method of claim 1, wherein determining a number of tasks associated with a given geography comprises:
determining a first number of tasks associated with a first bucket of the given geography; and
determining a second number of tasks associated with a second bucket of the given geography.

3. The method of claim 2, wherein determining a number of technicians dispatched to the given geography comprises:
determining a first number of technicians dispatched to the first bucket of the given geography; and
determining a second number of technicians dispatched to the second bucket of the given geography.

4. The method of claim 3, wherein determining the ratio of tasks per technician based on the number of tasks and the number of technicians comprises:
determining a first ratio of tasks per technician by dividing the first number of tasks by the first number of technicians; and
determining a second ratio of tasks per technician by dividing the second number of tasks by the second number of technicians.

5. The method of claim 4, wherein displaying the ratio of tasks per technician comprises:
displaying the first ratio of tasks per technician in a first cell associated with a graphical user interface (GUI); and
displaying the second ratio of tasks per technician in a second cell associated with the GUI.

6. The method of claim 1, wherein displaying the ratio of tasks per technician comprises:
receiving a request to display an aggregate ratio of tasks per technician associated with a selected plurality of turfs; and
in response to the request, displaying the aggregate ratio of tasks per technician associated with the selected plurality of turfs.

7. The method of claim 1, wherein displaying the ratio of tasks per technician comprises displaying a corresponding ratio of tasks per technician for each of a plurality of buckets, the plurality of buckets comprising at least one of a plain old telephone service (POTS) bucket, a digital subscriber line (DSL) bucket, and a cable bucket.

8. A system for providing a ratio of tasks per technician, comprising:
a memory for storing a program containing code for providing a ratio of tasks per technician;
a processor functionally coupled to the memory, the processor being responsive to computer-executable instructions contained in the program and operative to:
determine a number of tasks associated with a given geography,
determine a number of technicians dispatched to the given geography,
determine the ratio of tasks per technician based on the number of tasks and the number of technicians, and
determine the ratio of tasks per technician.

9. The system of claim 8, wherein to determine a number of tasks associated with a given geography, the processor is further operative to:
determine a first number of tasks associated with a first bucket of the given geography, and
determine a second number of tasks associated with a second bucket of the given geography.

10. The system of claim 9, wherein to determine a number of technicians dispatched to the given geography, the processor is further operative to:
determine a first number of technicians dispatched to the first bucket of the given geography, and
determine a second number of technicians dispatched to the second bucket of the given geography.

11. The system of claim 10, wherein to determine the ratio of tasks per technician based on the number of tasks and the number of technicians, the processor is further operative to:
determine a first ratio of tasks per technician by dividing the first number of tasks by the first number of technicians, and
determine a second ratio of tasks per technician by dividing the second number of tasks by the second number of technicians.

12. The system of claim 11, wherein to display the ratio of tasks per technician, the processor is further operative to:
display the first ratio of tasks per technician in a first cell associated with a graphical user interface (GUI), and
display the second ratio of tasks per technician in a second cell associated with the GUI.

13. The system of claim 8, wherein to display the ratio of tasks per technician, the processor is further operative to:
receive a request to display an aggregate ratio of tasks per technician associated with a selected plurality of turfs, and
in response to the request, display the aggregate ratio of tasks per technician associated with the selected plurality of turfs.

14. A computer-readable medium having instructions stored thereon for execution by a processor to perform a method for providing a ratio of tasks per technician, the method comprising:
determining a number of tasks associated with a given geography;
determining a number of technicians dispatched to the given geography;
determining the ratio of tasks per technician based on the number of tasks and the number of technicians; and
displaying the ratio of tasks per technician.

15. The computer-readable medium of claim 14, wherein determining a number of tasks associated with a given geography comprises:
determining a first number of tasks associated with a first bucket of the given geography; and
determining a second number of tasks associated with a second bucket of the given geography.

16. The computer-readable medium of claim 15, wherein determining a number of technicians dispatched to the given geography comprises:
determining a first number of technicians dispatched to the first bucket of the given geography; and
determining a second number of technicians for dispatched to the second bucket of the given geography.

17. The computer-readable medium of claim 16, wherein determining the ratio of tasks per technician based on the number of tasks and the number of technicians comprises:
determining a first ratio of tasks per technician by dividing the first number of tasks by the first number of technicians; and
determining a second ratio of tasks per technician by dividing the second number of tasks by the second number of technicians.

18. The computer-readable medium of claim 17, wherein displaying the ratio of tasks per technician comprises:
displaying the first ratio of tasks per technician in a first cell associated with a graphical user interface (GUI); and
displaying the second ratio of tasks per technician in a second cell associated with the GUI.

19. The computer-readable medium of claim 14, wherein displaying the ratio of tasks per technician comprises:
receiving a request to display an aggregate ratio of tasks per technician associated with a selected plurality of turfs; and
in response to the request, displaying the aggregate ratio of tasks per technician associated with the selected plurality of turfs.

20. The computer-readable medium of claim 14, wherein displaying the ratio of tasks per technician comprises displaying a corresponding ratio of tasks per technician for each of a plurality of buckets, the plurality of buckets comprising at least one of a plain old telephone service (POTS) bucket, a digital subscriber line (DSL) bucket, and a cable bucket.
